(19) United States
(12) Patent Application Publication
(10) Pub. No.: US 2009/0314223 A1
(43) Pub. Date: Dec. 24, 2009

(54) Pet trainer dispensing treats based on moisture detection

(76) Inventors: Jaewon John Yuu, San Diego, CA (US); Jaehee Jay Yuu, San Diego, CA (US)

Correspondence Address: Byeong Yuu, 13115 Sunstone Pt., San Diego, CA, 92130, US

(21) Appl. No.: 12/214,512

(22) Filed: Jun. 20, 2008

(51) Int. Cl. A01K 15/02; A01K 1/10; A01K 23/00

(52) U.S. Cl. 119/720; 119/56.1; 119/869

(57) ABSTRACT

A pet trainer for dispensing pet training treats based on urine detection is described. The pet trainer comprises a pet diaper including urine sensing electrodes which produces a signal indicating the existence of urine to a treat dispenser operative to dispense a predetermined amount of the pet training treats under the control of a controller. The treat dispenser further comprises a dispenser arm including a dispenser cover which is to be opened to directly reload the treats into the treat dispenser.

### BACKGROUND OF THE INVENTION

I. Field of the Invention

The present invention relates to a pet food dispenser. More specifically, the present invention relates to an apparatus for dispensing pet training treats based on moisture detection by wet sensor.

II. Description of the Related Art

Pet owners face persistent challenge to train pets, namely dogs, cats and other small animals. It is believed that the first step of pet training is to make it control the desire of urination to specifically designated location. There is an increasing need for techniques and devices to effectively train pets and particularly dogs to use a specific and restricted area as a bathroom rather than the entire carpet.

U.S. Pat. No. 5,085,174 discloses a trainer which is designed primarily for dogs having a wide panel surrounded by a continuous peripheral lip which seats one or more layers of newspaper. A pet tether connected centrally of the panel is attached at its distal end to the collar of the pet, preventing the pet from escaping beyond the confines of the panel so that the pet develops the habit of relieving itself on the newspapers in the pet trainer.

U.S. Pat. No. 7,263,953 discloses an integrated automatic device for training and feeding a pet, which also functions as a play mate while the owner is absent or otherwise engaged. A toy holder, when actuated by an ejector, throws a toy placed therein to a predetermined distance. This toy holder is actuated by a spring connected to a spring tensioner and a rotating shaft activated by a motor programmed by microprocessors. Voice command issuer and proximity switches are provided to regulate the functioning of the device. The device is connectable to a pet feeder including a feeder capable of supplying feed for a predetermined period.

U.S. Pat. No. 6,688,258 discloses a treat dispensing pet toy and training device consisting of a container with pet food or treats for interactive play with the owner of the pet. This toy could dispense treat and the treat is visible to the pet, motivating the pet to play with the owner to gain access to the treat.

Nevertheless, these devices are not enough to effectively encourage pets particularly dogs to use a specific and restricted area to urinate. It is, therefore, an object of the present invention to provide an improved automatic pet trainer overcoming the disadvantages of the prior arts by providing a wet sensor and controller to control motor rotation which is more sanitary, structurally robust, easily reloaded and dispensable, and cost effective.

### SUMMARY OF THE INVENTION

A novel and improved pet trainer for dispensing pet training treats based on urine detection is described. In accordance with one embodiment of the invention, a pet trainer comprises a pet diaper including sensing electrodes within the interior of the diaper for detecting the existence of urine thereon and producing signal indicating the existence of urine, a treat dispenser which is operative to dispense a predetermined amount of the pet training treats and includes a feed auger having screw threads to dispense treats by rotating and a motor rotating the feed auger; and a controller in electrical communication with the sensing electrodes and the motor in a way that it receives the signal indicating the existence of urine from the pet diaper and directs the motor to operate a predetermined amount of rotation. Further, treat dispenser further comprises a dispenser arm including a dispenser cover and a lower casing, wherein the dispenser cover is to be easily opened to directly reload the treats into the treat dispenser, and wherein the lower casing has an outlet for dispensing the pet training teats.

### BRIEF DESCRIPTION OF THE DRAWINGS

The features, objects, and advantages of the present invention will become more apparent from the detailed description set forth below when taken in conjunction with the drawings in which like reference characters identify correspondingly throughout and wherein:

FIG. 1 is an elevational view of a pet trainer according to one embodiment of the present invention;

FIG. 2 is a simplified illustration of a feed auger of the pet trainer of FIG. 1 according to one exemplary embodiment of the present invention;

FIG. 3 is an elevational view of a pet diaper incorporating sensing electrodes of FIG. 1 according to one embodiment of the present invention;

FIG. 4 is an expanded view of an end section of a pet diaper referred as A in FIG.3 according to one embodiment of the present invention;

FIG. 5 is a simplified illustration of a dispenser cover of FIG. 1 according to one exemplary embodiment of the present invention; and

FIG. 6 is a simplified circuit block diagram of a pet trainer of FIG. 1 according to one exemplary embodiment of the present invention.

### DETAILED DESCRIPTION OF THE PREFERRED EMBODIMENTS

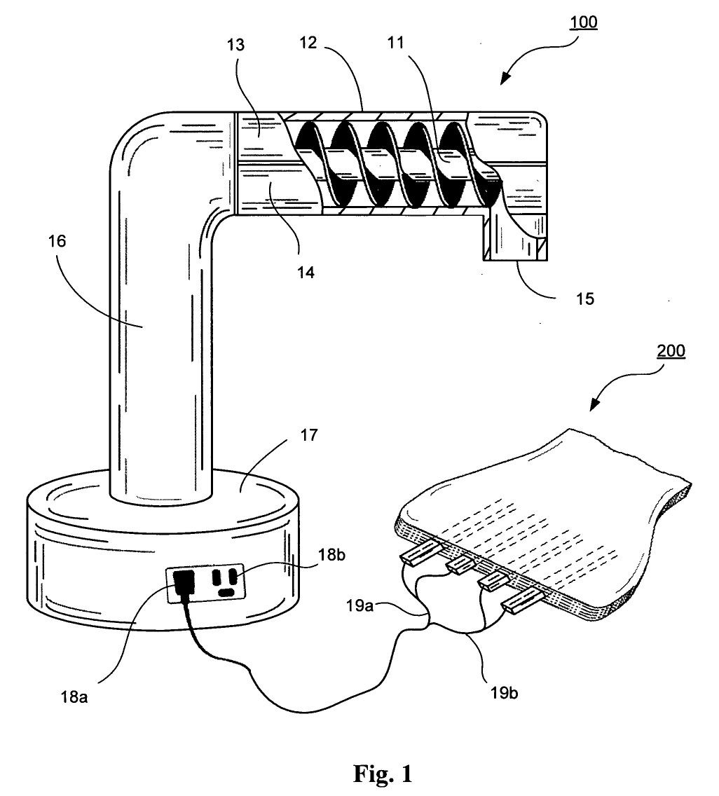

An elevational view of a pet trainer according to one embodiment of the present is shown in FIG. 1. A pet trainer comprises a treat dispenser 100 and a pet diaper 200. A treat dispenser 100 includes base 17, column 16, and dispenser arm 12. A base 17 includes a signal input 18a and a power inlet 18b. A signal is transmitted from a pet diaper 200 when it detects moisture thereon such as urine of a dog, which will be described with regard to FIG. 3 in more detail. The signal from a signal input 18a is transmitted to controller which then commands a motor rotation. The transmission of signal indicating detection of moisture such as urine does not limited to wired communication. Once the pet diaper 200 is equipped with wireless transmitter and treat dispenser 100 with receiver, signal transmission can be performed in wireless way which is generally known to the person skilled in the art. FIG. 6 is a simplified circuit block diagram of a pet trainer of FIG. 1 according to one exemplary embodiment of the present invention. A wet sensor 61 is disposed in a pet diaper 200. When a wet sensor 61 detects moisture for example pee by a dog, it transmits corresponding signal to controller 62 disposed within the treat dispenser 100. The controller 62 is adapted to control the rotation of a motor 24 resulting in dispense of appropriate amount of treats to pets. The controller 62 preferably controls the minimum period of dispensation and the amount of motor rotation and so on.

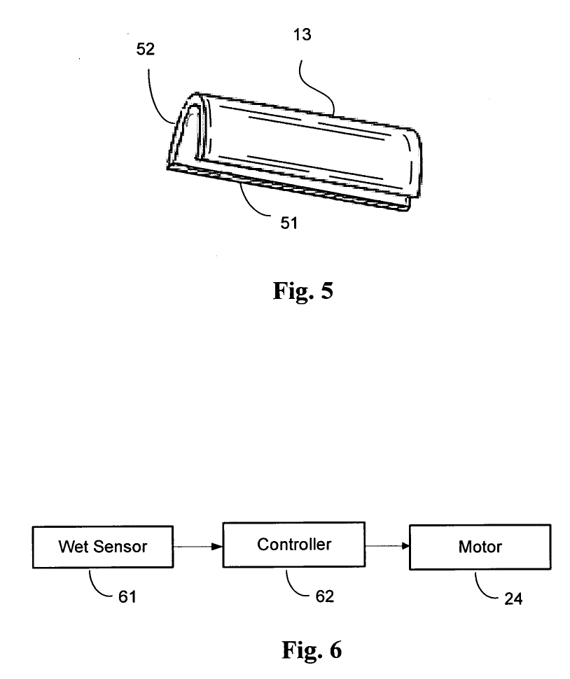

The dispenser arm 12 includes a lower casing 14 and a dispenser cover 13. Dispenser arm 12 is preferably cylindrical. Within the dispenser arm 12, a feed auger 11 is rotated to deliver treats through an outlet 15. FIG. 5 is a simplified illustration of a dispenser cover 13 of FIG. 1 according to one exemplary embodiment of the present invention. It is adapted for pet owner to easily open the cover 13 to directly reload treats to the feed auger 11. A joint section 51 of the dispenser cover 13 fits with the shape of the lower casing 14 of the dispenser arm. A joint section 52 of the dispenser cover 13 fits with the shape of the column 16 of the treat dispenser 100. The joint sections 51 and 52 can be configured according to conventional engagement methods such as friction engagement or annular groove and protrusions.

One advantage of the present invention over the prior arts is that the pet owner may customize the amount of dispense per operation. In other words, if the owner fills the space between screw threads of the feed auger 11 with larger amount of treats, the larger amount of treats will be dispensed per operation. Similarly, if the owner fills the space between screw threads of the feed auger 11 with smaller amount of treats, the smaller amount of treats will be dispensed per operation. Moreover, this structure allows a compact dimension of the treat dispenser because the present invention does not need a protruding hopper which is the container of pet food. The bulkiness of the device of the prior arts is therefore overcome by the present invention.

The present invention may also effectively convey solid, relatively hard treats without danger of breaking them. The food dispensers of the prior art have augers as a conveyance means of pet food, but are not generally suitable for large particles, such as alfalfa cubes. The large particles tend to become broken in prior arts when traveling through the auger, or when the particles are reloaded from a hopper into the conveyer because some are stuck at the hopper outlet before they are completely reloaded into the conveying auger. This may cause mechanical damage to the dispenser or malfunctioning of the device. These disadvantageous are effectively overcome in the present invention by adapting a dispenser cover 13 and Archimedes screw 22.

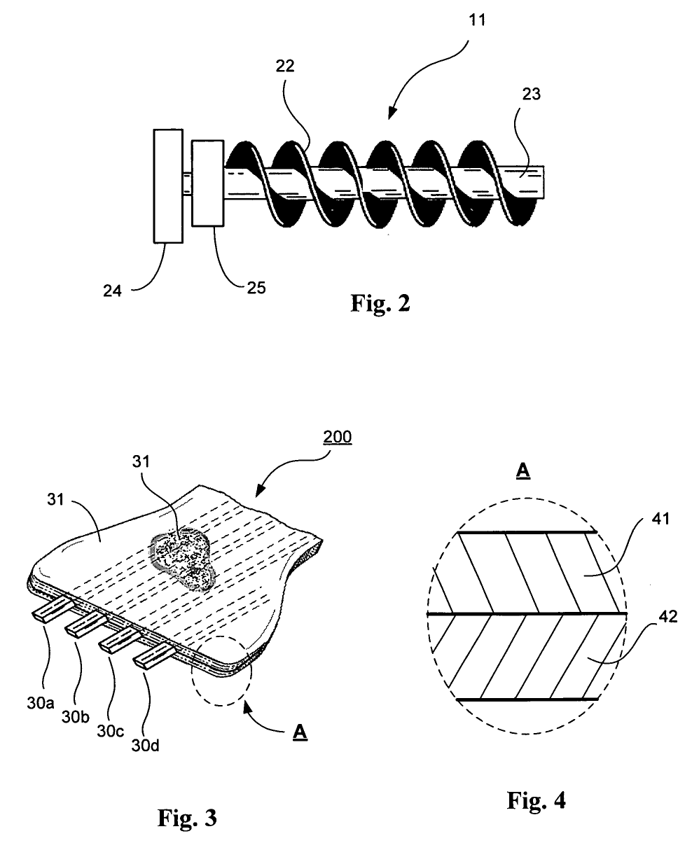

Referring back to FIG. 2, a feed auger of FIG. 1 according to one exemplary embodiment of the present invention is illustrated. The feed auger 11 preferably includes a feeder mechanism that comprises a shaft 23 and screw threads 22 surrounding the shaft 23. In accordance with a preferred embodiment of the present invention, the screw 22 is an Archimedes screw. Shaft 23 is preferably rotated by means of a motor 24, which is preferably connected to shaft 23 through a reduction gear 25 for an appropriate rotation of shaft 23.

Pet diaper 200 which is preferably disposable includes a pair of sensing electrodes 19a and 19b. The usage of a pair of sensing electrodes 19a and 19b is based on the fact that urine is a solution of among other things, electrolytes, and will conduct a current of electricity. Usually, urine contains not only water but also dissolved salts and ions. FIG. 3 is an elevational view of a pet diaper 200 incorporating sensing electrodes of the pet trainer of FIG. 1 according to one embodiment of the present invention. A conductive path is established between the electrodes 19a and 19b upon urination at urine spot 31 and a motor 24 is activated by the controller 62.

These may represent repeated patterns described on U.S. Pat. No. 6,200,250 to Janszen, which is fully incorporated by reference herewith. A set of sensing electrodes 30a, 30b, 30c, and 30d are printed or otherwise pre-assembled into an inner layer of the pet diaper 200. In FIG. 3, a plurality of individual sensing electrodes 30a˜30d may function together to effectively form pairs of electrodes corresponding to sensing electrodes 19a and 19b in FIG. 1. The sensing electrodes 30a˜30d may be filaments, wires, yarn, ribbon, foil, fabric or film made from conductive material. The sensing electrodes 30a˜30d may be filaments, yarn, ribbon, fabric or film that bears conductive filler material, which is coated with conductive material, or with surfaces subjected to a conversion process or suffused with a material that renders said surfaces conductive. The sensing electrodes 30a˜30d may be in the form of yarn that includes continuous or discontinuous lengths of conductive filament or wire, that is wrapped with conductive filament or wire, that is infused with material that is conductive, or that is infused with material that bears conductive filler material. The sensing electrodes 30a˜30d may be liquid or plastic material that is conductive or that bears conductive filler material, such as a thermoplastic, wax, paste, gel, latex, adhesive, or ink, that may be selectively applied onto a surface or into an absorbent matrix by methods such as printing, rolling, or extrusion.

In FIG. 3, a plurality of individual sensing electrodes 30a˜30d may function together to effectively form pairs of electrodes corresponding to sensing electrodes 19a and 19b in FIG. 1.

FIG. 4 is an expanded view of a section referred to as A of a pet diaper sheet 31 of FIG. 3 according to one embodiment of the present invention. Diaper sheet 31 preferably comprises inner sheet 41 and backing sheet 42. Preferably, electrodes 30a˜30d are located within inner sheet 41. Backing sheet 42 is preferably more absorbent than inner sheet 41 in order to effectively transfer urine from inner sheet to backing sheet. This will help effectively dry diaper layer where electrodes 30a˜30d are located. This arrangement will prevent redundant operation of the dispenser. Backing sheet 42 is preferably filled with superabsorbent fill material derived from a family of hydrophilic polymers known as polyacrylates.

Thus, an apparatus for dispensing pet training treats based on moisture detection by wet sensor was disclosed. The description is provided to enable any person skilled in the art to make or use the present invention. The various modifications to these embodiments will be readily apparent to those skilled in the art, and the generic principles defined herein may be applied to other embodiments without the use of the inventive faculty. Thus, the present invention is not intended to be limited to the embodiments shown herein but is to be accorded the widest scope consistent with the principles and novel features disclosed herein.

I (we) claim:

1. An apparatus for dispensing pet training treats based on urine detection comprising:
a pet diaper including sensing electrodes within the interior of said diaper for detecting the existence of urine thereon and generating signal indicative of existence of urine thereon;
a treat dispenser operative to dispense a predetermined amount of pet training treats, said treat dispenser including a feed auger having screw threads to dispense said pet training treats by rotating and a motor rotating said feed auger; and
a controller in electrical communication with said sensing electrodes and said motor, said controller receiving said signal indicative of existence of urine from said pet diaper and directing said motor to operate a predetermined amount of rotation.

2. An apparatus as defined in claim 1, wherein said treat dispenser further comprising:
a base including said controller, said base further includes a receiver of said signal indicative of existence of urine; and
a column connecting said base and said feed auger.

3. An apparatus as defined in claim 1, wherein said treat dispenser further comprising:
a dispenser arm including said feed auger therein, said dispenser arm further including a dispenser cover and a lower casing, wherein said dispenser cover is to be opened to directly reload said treats into said feed auger, and wherein said lower casing has an outlet for dispensing said teats.

4. An apparatus as defined in claim 1, wherein said pet diaper includes a transmitter adapted to transmit said signal in wireless form, and wherein said treat dispenser includes a receiver adapted to receive said signal in wireless form.

5. An apparatus as defined in claim 1, wherein said screw threads are Archimedes screw threads.

6. An apparatus as defined in claim 1, wherein said pet diaper comprising:
an inner sheet including said sensing electrodes therein; and
an backing sheet which is more absorbent than said inner sheet.

7. A method for dispensing pet training treats based on urine detection comprising:
detecting at a pet diaper the existence of urine thereon using sensing electrodes disposed within interior of said pet diaper
transmitting said signal indicative of existence of urine to controller located within a treat dispenser;
receiving at said controller said signal indicative of existence of urine;
in response to said received signal at controller, directing a motor of a feed auger to operate a predetermined amount of rotation; and
dispensing a predetermined amount of said pet training treats.
